(19) United States
(12) Patent Application Publication
(10) Pub. No.: US 2009/0003248 A1
(43) Pub. Date: Jan. 1, 2009

(54) CONFERENCE SYSTEM AND SERVER APPARATUS THEREFOR

(75) Inventors: Koji Shima, Sagamihara-shi (JP); Yasumasa Sasaki, Tachikawa-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/133,846

(22) Filed: Jun. 5, 2008

(30) Foreign Application Priority Data
Jun. 29, 2007 (JP) 2007-173039

(51) Int. Cl. H04L 12/16

(52) U.S. Cl. 370/260

(57) ABSTRACT

According to one embodiment, a conference system which includes a plurality of client terminals to be connected with a communication network, and a conference unit supporting conferences to be held among the plurality of client terminals via the communication network, includes a resource control unit which dynamically allocate a resource of the conference unit to be consumed for supporting the conferences for each group to individually hold the conferences in response to occurrences of events showing changes in states of client terminals belonging to the group, and a release control unit which releases at least a part of the resources to be allocated to groups in which the events occur while the conferences are held under preset conditions.

### CROSS-REFERENCE TO RELATED APPLICATIONS

This application is based upon and claims the benefit of priority from Japanese Patent Application No. 2007-173039, filed Jun. 29, 2007, the entire contents of which are incorporated herein by reference.

### BACKGROUND

1. Field

One embodiment of the present invention relates to a conference system and a server apparatus therefor. The conference system is actualized, for example, as an application of a telephone system to be formed by using an Internet Protocol (IP) technique.

2. Description of the Related Art

A system actualizing voice communication via a best effort type network such as the Internet has been known. Such a system has been called an IP telephone system or a Voice over IP (VoIP), and has been applied not only to a wide range telephone network but also to a local communication network such as a private telephone network. Hereinafter, telephone terminals in this kind of system are referred to as IP telephone sets including fixed telephone sets and software phones.

In recent years, a conference system called a visual communication system (VCS) has become widely used by using this kind of system (e.g., refer to Jpn. Patent Appln. KOKAI Publication No. 2006-270166). This reference has disclosed a system in which voice communication by means of a telephone exchange (hereinafter, it is abbreviated to an exchange) which has been widely used conventionally is cooperated with video communication by a visual communication server VCS server.

A control form of the visual communication system is generally described as follows. A change in call state among extension terminals to be connected to the exchange makes the exchange transmit a call information event (origination side device information, termination side device information). The VCS server received this call information event to interpret the connection states among extension terminals on the basis of the received event. Depending on the connection states, the VCS server instructs starts and terminations of visual communications to visual clients to be associated with extension terminals.

Meanwhile, in recent years, if the number of participates (hereinafter, referred to as video members) is large, a technique which combines conferences by a device called a multi-point control unit (MCU) has been examined (e.g., Jpn. Pat. Appln KOKAI Publication No. 2007-259270). Using the MCU for combining the conferences establishes a video stream among clients and the MCU. In relation to this technique, a system which intends effective application of a conference resource by enabling selection of the video members in response to a demand from a user has been examined and the system has been filed as Japanese Patent Application No. 2006-330943 (filed Dec. 7, 2006).

Most of client terminals to participate in the conference have video transmission and reception functions, the on and off states of the functions significantly affect on a consumption amount of the conference resources. In an existing technique, even if any client turns off the video transmission and reception function while the conference using the MCU is held, the conference resource of the MCU is continuously secured until the client himself or herself leaves from the conference. Even if a client who has not been connected with a video camera participates in the conference, and even if a client of whom the video transmission and reception function has been turned off participates in the conference, the conference resource of the MCU is used. Therefore, there is a problem such that the conference resource of the MCU cannot be effectively utilized at a maximum.

Other than this, there is the following problem. That is, depending on the number of participants in the conference, the conference system is not required the MCU, and peer-to-peer communications among clients may be enough for the conference system. For instance, in a certain form, four persons become the boundary, and then, if the number of the clients is three, the conference system adopts peer-to-peer and if the number of the clients is four or larger, the conference system utilizes the MCU. In this form, in switching to another speaker while the conference is held among four persons, the conference system temporarily becomes a state for three persons, becomes peer-to-peer communication and opens the resource of the MCU. In this state, if the resource is taken by another conference, an original conference form which the resource has been completely transferred becomes impossible to utilize the MCU. In this way, there is still room for improvement in the existing technology and some pieces of technical development have been expected.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a system view depicting a form of an embodiment of a conference system regarding the invention;

FIG. 2 is a view depicting an example of setting condition information 70b of FIG. 1;

FIG. 3 is a view depicting an example of timer set value information 70c of FIG. 1;

FIG. 4 is a view depicting an another example of the timer set value information 70c of FIG. 1;

FIG. 5 is a view depicting an example of a management table for use in setting whether a conference resource of a multi-point control unit (MCU) 50 should be used or not;

FIG. 6 is a flowchart depicting an example of a processing procedure in holding a video conference using the conference resource of the MCU 50;

FIG. 7 is a flowchart depicting an example of a processing procedure in holding a video conference without using the conference resource of the MCU 50;

FIG. 8 is a flowchart depicting an example of a processing procedure when a client starts the video conference; and

FIG. 9 is a flowchart depicting an example of a processing procedure in decreasing the number of speakers in holding a multi-person conference by the use of the conference resource of the MCU 50.

### DETAILED DESCRIPTION

Various embodiments according to the invention will be described hereinafter with reference to the accompanying drawings. In general, according to one embodiment of the invention, a conference system which includes a plurality of client terminals to be connected with a communication network, and a conference unit supporting conferences to be held among the plurality of client terminals via the communication network, comprising: a resource control unit which dynamically allocate a resource of the conference unit to be consumed for supporting the conferences for each group to individually hold the conferences in response to occurrences of events showing changes in states of client terminals belonging to the group; and a release control unit which releases at least a part of the resources to be allocated to groups in which the events occur while the conferences are held under preset conditions.

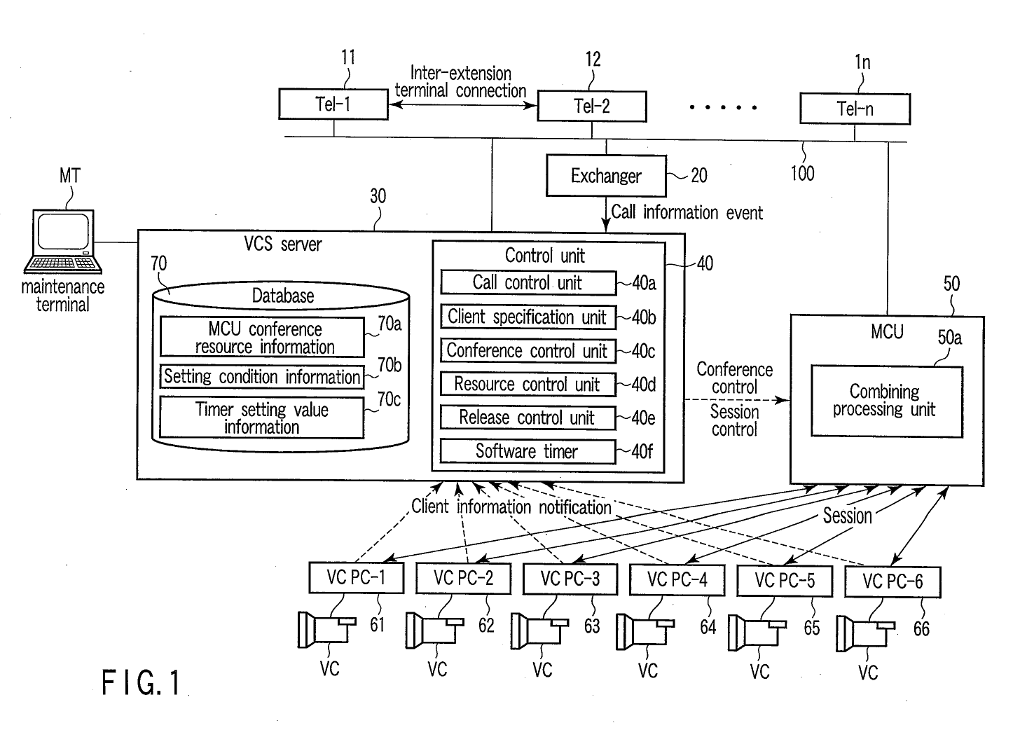

According to an embodiment, FIG. 1 shows a system view illustrating a form of an embodiment of a conference system regarding the present invention. In FIG. 1, a plurality of IP telephone sets 11-1n are connected with an exchange 20 via an IP network 100. The IP telephone sets 11-1n are, for example, exclusive telephone terminals. Or the IP telephone sets 11-1n are soft-phones in which telephone software is installed in computers. A visual communication system server (VCS server) 30 and an MCU 50 are also connected to the IP network 100. The VCS server 30 may be connected to a maintenance terminal MT as a setting unit so as to set various items of data.

The VCS server 30 manages the MCU 50 and a plurality of visual clients 61-66 via the IP network 100. The visual clients 61-66 are objects equivalent to participants capable of becoming conference members, and, for example, computer terminals function by individually cooperating with the IP telephone sets 11-1n. Therefore, the number of the visual clients 61-66 is not limited to six.

The visual clients 61-66 are each provided with video cameras VCs which acquire visual data of speakers (users) and transmit the visual data to the IP network 100. Voice data of the speakers may be also acquired with the video cameras VCs. A quantity of a resource needed by the visual communication conference is significantly affected by the presence/absence of the video camera VC or on/off of its function.

If a processing ability of the VCS server 30 is enough in comparison with a scale or the number of the visual communications, the visual communications may be achieved by peer-to-peer communication among client terminals. However, such a situation is not always comes true. In such a meaning, The MCU 50 performs its part as a support device to make visual communication. The resource of the MCU is limited.

The MCU 50 is provided with a combining processing unit 50a. The processing unit 50a combines video data and voice data transmitted via the IP network 100 to actualize multiple pieces of visual communication by a plurality of members. In a state of enough resources of the MCU 50, as shown in FIG. 1, a session among all the visual clients 61-66 and the MCU 50 is established; this conference is composed of all the conference members. The members of the conference are notified to each visual client 61-66, the names of the participants are displayed on the client terminals and video images of all the participants are displayed on the client terminals.

The VCS server 30 includes a control unit 40 and a database unit 70. The control unit 40 includes a call control unit 40a, a client specification unit 40b, a conference control unit 40c, a resource control unit 40d, a release control unit 40e and a software timer 40f, as its processing functions.

Among of them, the call control unit 40a acquires a call information event regarding various kinds of call control from the exchange 20, and executes processing such as call connection and session control regarding the IP telephone sets 11-1n and visual clients 61-66 in cooperation with the exchange 20. The client specification unit 40b specifies members (clients) to participate in the conference under a given set condition. Information on the specified members is used for session control by the conference control unit 40c.

The conference control unit 40c detects the remaining quantity of the resource of the MCU 50 for supporting the conference to record the remaining quantity in MCU conference resource information 70a of the database unit 70. The conference control unit 40c constitutes members to participate in the conference in response to the remaining quantity of the resource. The members are selected in a form corresponding to a request from the client, and the selected members are notified to the visual clients 61-66. At the time of the start of the conference, the MCU 50 receives session control information which reflects the structure of the members from the conference control unit 40c to form the session only among the selected members.

The resource control unit 40d allocates the conference resource of the MCU 50 to be consumed for supporting the conference for each call group which individually holds conferences. Each call group is a set of members composed of each conference. Usually, the scale of the call group and the scale of the conference vary while the conference is held, and in response to the variation, the resource control unit 40d dynamically varies the allocation quantity of the resources to each group. As regards one of causes to vary the allocation quantity of the resources, a change in a state of a visual client belonging to a call group is designated. This change is recognized by the system as an occurrence of an event.

When the release control unit 40e detects that an event related to resource allocation has occurred in the system and that the rest of the resource has produced the remainder of the resource, the release control unit 40e releases the remainder of the resource under a preset condition. That is the release control unit 40e at least a part of the resource allocated to the group that has caused an event such as a decrease (or an increase) in the number of participating clients, a changeover of speakers, and turning on/off of a video camera VC while the conference is held under the preset condition.

The software timer 40f counts a defined time regarding the resource release. The database unit 70 stores the MCU conference resource information 70a, the setting condition information 70b and timer set value information 70c in its storage area. Among of them, the resource information 70a is the information in which the resource of the MCU 50 to be consumed for supporting the visual communication is subjected to the database. This database is used, for instance, in order to manage what the extent of the resources has been currently allocated for each call group. With the change in members who have been participated in the conference and with the version up of the system and so on, the resource information 70a varies.

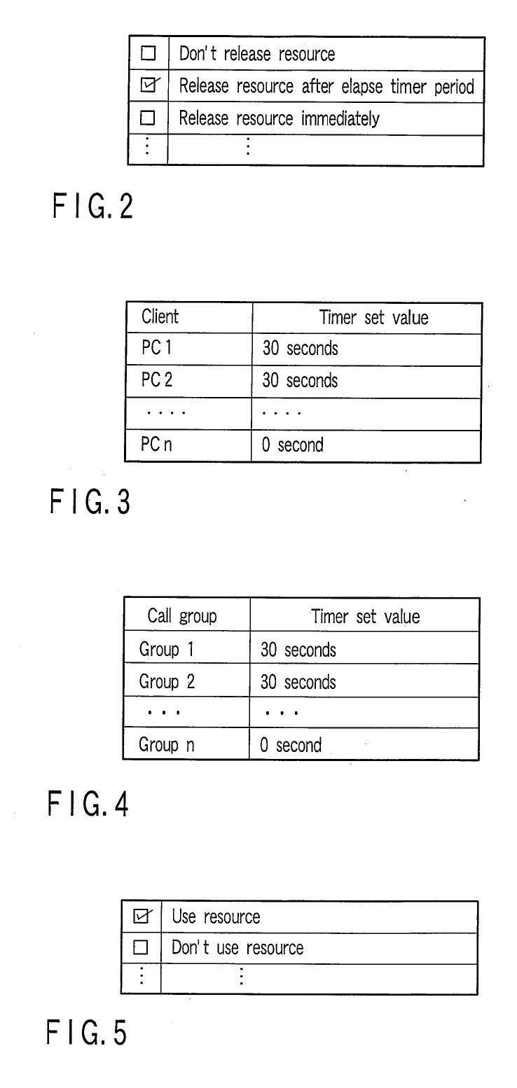

FIG. 2 shows an example of the setting condition information 70b. The condition information 70b is stored in a table in which the condition, making the release control unit 40e release the resource of the MCU 50, is defined. In FIG. 2, a flag has been set in such a condition that the resource is released after the elapse of a timer period. Thereby, the release control unit 40e releases the redundancy resource in accordance with this condition. The condition also may be set for each call group or for each visual client by further segmentalizing.

FIG. 3 shows a view illustrating an example if the timer set value information 70c. This example relates to the condition for releasing the resource after the elapse of the timer period, and is used when the condition is set. As shown in FIG. 3, the timer set value to be counted by the software timer 40f is registered for each visual client terminal (PC1-PCn). Using the table releases the resource, for example, after 30 seconds from the time when the redundancy resource has produced with a change if a state of the visual client terminal. If a state change event is further occurs before the elapse of the time and results in short of redundancy resource, it is sure that the resource remains not to be released.

FIG. 4 shows a view illustrating other example of the timer set value information 70c. In FIG. 4, the timer set value to be counted by the software timer 40f is registered for each call group. Using the table of release conditions enables managing the change if the redundancy resource for each group, and achieving control such as a release of the redundancy resource, for example, after 30 seconds from the time point of the occurrence of the change. The change in the state in the call group occurs, for example, in a case in which a call transfer event so as to switch speakers and the number of speakers is temporarily varies.

FIG. 5 shows a view illustrating an example of a management table to be used in order to determine if the resource of the MCU 50 is used or to set the recourse itself. For instance, the management table is used in order to decide whether or not the resource of the MCU 50 is used in a state in which the video camera function of the visual client in the group has been turned off for each call group.

Since it has been set to use the resource in FIG. 5, even if the video camera function is turned off (a state of little resource consumption), the conference resource of the MCU is used by default at the time of the start of the video conference. Other than this, a form to determine the use of the conference resource of the MCU in response to the number of clients participating in the conference is a possible approach. For instance, there is a form in which at a conference with the number of participating clients is not larger than three, the conference resource is not used, and the conference resource is used for the first time when the number of the clients becomes four or larger.

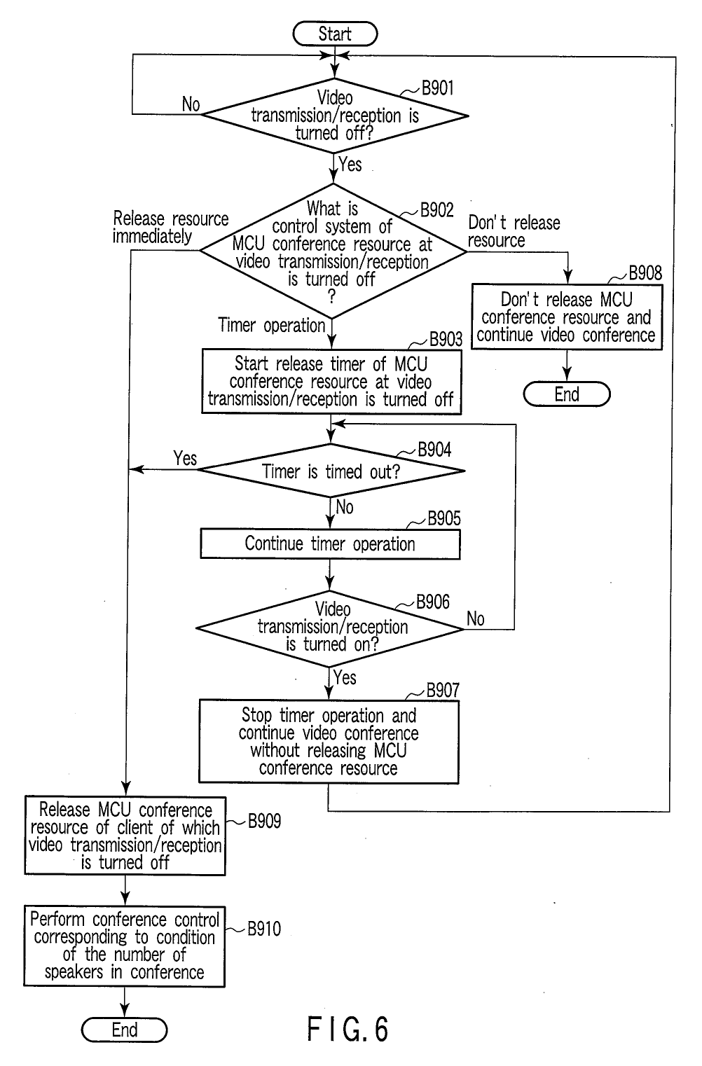

The set data for each table shown in FIGS. 2 to 5 is prepared in advance due to the operation of the maintenance terminal MT by the manager. Even in operation of the system, this setting may be changed. If the timer set values are equivalent to zero seconds, in FIGS. 3, 4, the redundancy resources are immediately released, and becomes into the same state in which the flag is set to the condition of the immediate release of the resource in FIG. 2. Conversely, if the timer set values are equivalent to infinity (∞), at least until the end (disbandment), the redundant resource will not be released. Next, the procedure of the release of the event will be described with reference to FIGS. 6-9. The event which becomes a trigger of the release of the resource is turning on/off of a video transmission and reception function, or a decrease in the number of the speakers.

FIG. 6 shows a flowchart illustrating an example of a processing procedure in holding the video conference using the conference resource of the MCU 50. In the flowchart, it is assumed a state that the video transmission and reception function of the visual client terminal is turned on at the time of the start.

In FIG. 6, if the video transmission and reception function is turned off at any of the client terminals (Yes, Block B901), this event is notified to the VCS server 30 as client information notification. In response to this notification, the VCS server 30 confirms the setting of the table in FIG. 2 (Block B902).

In Block B902, if the setting instructs ‘release resource immediately’, the processing procedure shifts to Block 909 and the resource of the relevant client is immediately released. If the setting instructs ‘don't release resource’, the VCS server 30 does not release the resource of the MCU conference to continue the video conference (Block B908).

If the setting on the table indicates ‘release the resource after the elapse of the timer period’, the VCS server 30 reads the timer set value from the table of FIG. 3 or FIG. 4. The VCS server 30 then starts a timer corresponding to a client terminal of which the video transmission and reception function has been tuned off (Block B903). After this, a time-out of the timer is checked without interruption (Block B904).

In a state in which the software timer 40f does not time out, the VCS server 30 continues count processing (a timer operation) (Block B905), and also checks whether or not the client turns on the video transmission and reception function again (Block B906). If the video transmission and reception is not turned on, the processing procedure returns to Block B904. If the video transmission and reception function is turned on (Yes, Block B906), the VCS server 30 stops the timer operation and continues the video conference without releasing the resource of the MCU conference (Block B907).

If the time times out in Block B904, the VCS server 30 releases the resource of the MCU conference resource which has been allocated to the client terminal the video transmission and reception function of which has been turned off (Block B909), and performs conference control corresponding to the condition of the number of the speakers in the conference (Block B910).

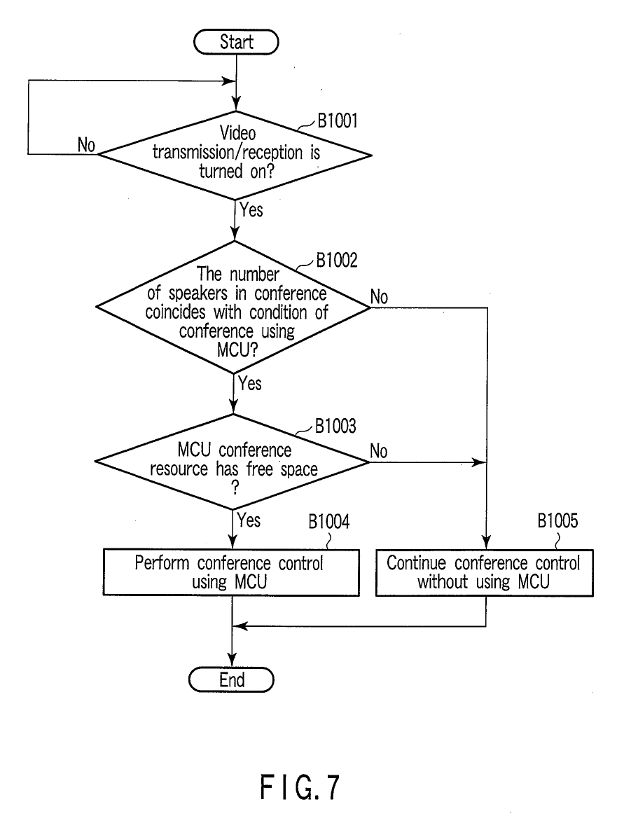

FIG. 7 is a flowchart illustrating an example of a processing procedure while the video conference not using the conference resource of the MCU 50 is held. This flowchart assumes a state in which the video transmission and reception function of the visual client terminal is turned off at the time point of the start.

In FIG. 7, if the video transmission and reception function is turned on at any client terminal (Yes, Block B1001), this event is notified as client information notification to the VCS server 30. In response to this notification, the VCS server 30 checks whether or not the number of speakers in the conference coincides with the condition of the conference using the MCU 50 (Block B1002). That is, the VCS server 30 checks, for example, the number of the speakers in the conference is not larger than three (not using MCU 50), or not smaller than four (using the MCU 50).

If the number of speakers in the conference does not satisfy the condition of the conference using the MCU 50, the VCS server 30 continues the conference control not using the MCU 50 (Block B1005). Conversely, if the number of the speakers in the conference satisfies the condition of the conference using the MCU 50, the VCS server 30 checks whether or not the MCU conference resource has any redundancy (free space) of the resource of the MCU conference (Block B1003). If the MCU conference resource has no free space, the processing procedure shifts to Block B1005. If the MCU conference resource has any free space, the VCS server 30 resets the session to control the conference in a form using the MCU 50 (Block B1004).

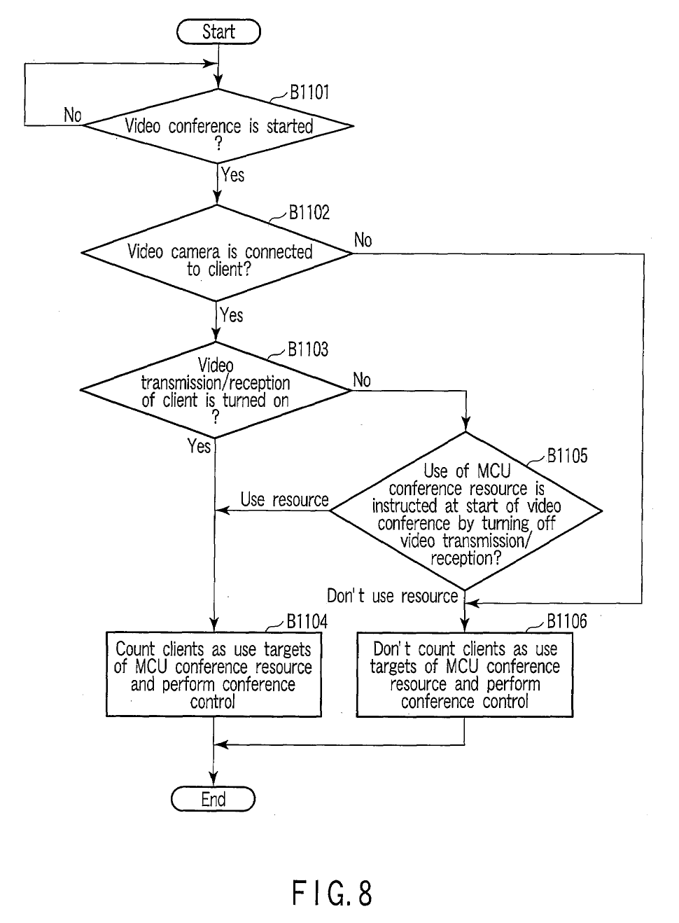

FIG. 8 shows a flowchart illustrating an example of the processing procedure when a client starts the video conference. In FIG. 8, if the client starts the video conference (Block B1101), the VCS server 30 checks whether or not the video camera VC is connected to the client (Block B1102). If the video camera VC is not connected, the VCS server 30 does not count the clients as expected users of the MCU conference resource and performs the conference control (Block B1106).

If the video camera VC is connected to the client, the VCS server 30 checks whether the video transmission and reception function is turned on or off (Block B1103). If the video transmission and reception function is turned off, the VCS server 30 confirms the setting of the table of FIG. 5 under the condition that the video conference is started by turning off the video transmission and reception function (Block B1105). If the setting is indicates ‘use the resource’, the processing procedure shifts to Block B1104. If the setting indicates ‘don't use the resource’, the processing procedure shifts to Block B1106.

Conversely, if the video transmission and reception function is turned on in Block B1103, the VCS server 30 counts its clients as the expected users of the MCU conference resource and performs the conference control (Block B1104).

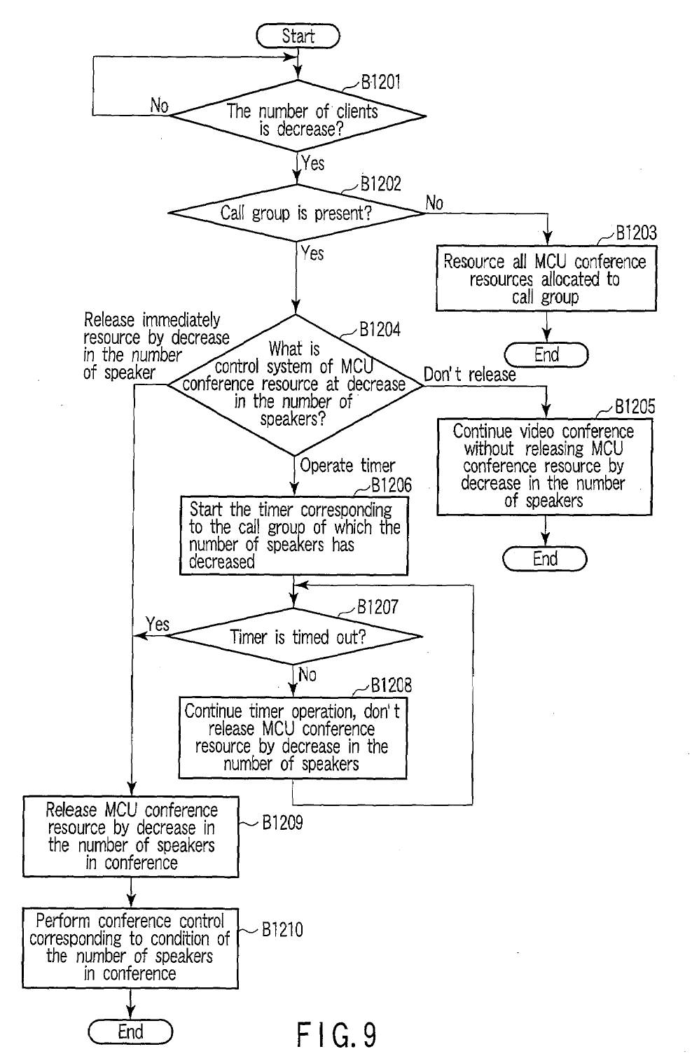

FIG. 9 is a flowchart illustrating an example of a processing procedure in decreasing the number of the speakers while the conference using the conference resource of the MCU 50 is held. In this flowchart, especially, for the changeover of the speakers, conference organizer operates a transfer of a call; thereby the flowchart illustrates a process to temporarily decrease the number of the speakers.

When the organizer of the conference depresses a conference transfer key of her or his own IP telephone set (or a client terminal), the transfer processing starts, the call is temporarily disconnected then the number of the speakers decreases (Yes, Block B1201). Thus, a call information event showing that the call state has varied is notified from the exchange 20 to the VCS server 30. When receiving this notification, the VCS server 30 checks the MCU conference resource information 70a, and determines whether or not any call group is present at that time point (Block B1202).

If any call group is not present, all the resources of the MCU conference which is currently allocated to the call groups are released (Block B1203). If any call group is present, the VCS server 30 confirms the table of FIG. 2 (Block B1204). If the setting instructs ‘Don't release’ the VCS server 30 continues the video conference without having to release the resources of the MCU conference by the decrease in the number of speakers (Block B1205).

If the setting shows ‘Release resource after elapse of timer period’, the VCS server 30 reads the timer set value from the table in FIG. 3 or FIG. 4. The VCS server 30 starts the timer corresponding to the call group of which the number of speakers has decreased (Block B1206). After this, the time-out of the timer is checked without interruption (Block B1207).

In a state in which the software timer 40f is not timed out, the VCS server 30 continues the count processing (timer operation), and a state in which the resources of the MCU conference are not released by the decreased number of the speakers (Block B1208). If the timer times out in Block B1207, the VCS server 30 releases the resources of the MCU conference by the decreased number of the speakers (Block B1209), and performs the conference control in response to the condition of the number of the speakers in the conference (Block B1210). In contrast, if the setting confirmed in Block B1204 instructs ‘release resource immediately’, the processing procedure proceeds to Block B1209 as it is.

As described above, in this embodiment, even when the event of turning on/off of the video transmission and reception function, or the decrease in the speakers is detected, the conference system does not blindly release the resources of the MCU 50 which have been free. That is, the VCS server 30 confirms the setting of the processing in generation of the redundant resources from the setting condition information 70b, and performs the processing under the condition corresponding to the setting. For instance, if the processing condition is set to release the resources after the elapse of 30 seconds, the VCS server 30 releases the redundant resources after the software timer 40f counts 30 seconds from the occurrence of the event.

In a four-person conference using the conference resource of the MCU 50, when the conference organizer expects to perform a transfer operation to other speakers and shift to another four-person conference, the conference organizer firstly reserves the conference to transfer the call, thereby the video conference temporarily becomes a three-person conference excluding the conference organizer. In this case, if the VCS server 30 immediately releases the conference resources of the MCU 50, a peer-to-peer communication environment for each three person is subjected to be formed.

Although a four-person conference state is set again after waiting for the response from a transfer destination, if the conference resource of the MCU 50 is acquired by other user, the conference resource for making visual communication among four persons again results in having no free space. In other words, although the four-person conference using the conference resource of the MCU 50 may be realized before the conference organizer transfers the calls to other speakers, the four-person conference using the conference resource of the MCU 50 may not be held at the time of the end of the transfer operation. Conversely, this embodiment may select control systems for the conference resource, while many-person conference using the conference resource of the MCU 50 is held, even if the number of speakers decreases due to the variation of the call state, the situation described above does not occur. In this embodiment, even when the client turns off the video transmission and reception function in the many-person conference using the conference resource of the MCU 50, a conference resource control system of the MCU 50 may be selected. In either case, especially, user the setting condition to release the resource after waiting for the count of the timer period, the count value of the timer may be arbitrarily set.

Of course, when the conference resource of the MCU 50 is allocated once to the call group in conference depending on the setting condition, the conference resource may not be released while the call group is present. If any client turns on the video transmission reception function while the video conference not using the conference resource of the MCU 50 is held, the turning on coincides with the condition of the number of the speakers in the conference for using the conference resource of the MCU 50, and also the conference resource of the MCU 50 has any free space, the conference system may uses the conference resource of the MCU 50.

If the video camera VC is not connected to the client terminal at the time of start of the video conference, the conference system may not use the conference resource of the MCU 50. Further, in starting the video conference in a state of turning off of the video transmission and reception function of the client, the turning off coincides with the condition of the number of the speakers in the conference for using the conference resource of the MCU 50, and also the conference resource of the MCU 50 has any free space, the conference system may select by setting how to allocate the conference resource of the MCU 50.

Like this, the embodiment may sensitively set the conditions such that the conference resource of the MCU 50 should be used or not, or how to release the redundant resources. Thus, the conference system which has achieved further effective utilization of the conference resource may be provided.

The invention is not limited to the foregoing embodiment. For instance, while the embodiment has described that the maintenance terminal MT may set a condition of resource release, counted value of the timer, etc., the conference system may be configured to implement that setting from the IP telephone sets 11-1n or visual clients 61-66. Various kinds of setting may individually set for each client or each call group.

In the flowchart of FIG. 9, a transfer operation in a many-person conference is taken by way of example as a factor of a decrease in the number of speakers. Other than this, a case in which a speaker in participation in the conference simply leaves from the conference is thought as a factor of a decrease in the number of speakers in the conference. In this way, under a situation without departing from the spirit or scope of the general inventive concept of the invention, the invention may control the conference resource of the MCU 50.

The resource control unit and the release control unit may be provided as processing functions of an exclusive server device.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A conference system which includes a plurality of client terminals to be connected with a communication network, and a conference unit supporting conferences to be held among the plurality of client terminals via the communication network, comprising:
a resource control unit which dynamically allocate a resource of the conference unit to be consumed for supporting the conferences for each group to individually hold the conferences in response to occurrences of events showing changes in states of client terminals belonging to the group; and
a release control unit which releases at least a part of the resources to be allocated to groups in which the events occur while the conferences are held under preset conditions.

2. The conference system according to claim 1, wherein
the event is the change of the number of the client terminals in the groups.

3. The conference system according to claim 1, wherein
the conditions equivalent to elapse of defined times from occurrences of the events.

4. The conference system according to claim 1, wherein
the plurality of client terminals each includes
video transmission and reception functions of transmitting visual data to the communication network, and
the event is the change of the video transmission and reception functions of the client terminals from on to off.

5. The conference system according to claim 1, wherein
the event is the temporary change of the number of the client terminals for switching users participating in the conference.

6. The conference system according to claim 1, wherein
the event is the changes of call states among client terminals which form sessions in the groups.

7. The conference system according to claim 1, further comprising:
a unit for setting which sets the conditions.

8. A server device for use in a conference system which includes a plurality of client terminals to be connected with a communication network, and a conference unit supporting a conference to be held among the plurality of client terminals via the communication network, comprising:
a resource control unit which dynamically allocates a resource of the conference unit to be consumed for supporting the conferences for each group to individually hold the conferences in response to occurrences of events showing changes in states of client terminals belonging to the group; and
a release control unit which releases at least a part of the resources to be allocated to groups in which the events occur while the conferences are held under preset conditions.

9. The server device according to claim 8, wherein
the event is the change of the number of the client terminals in the groups.

10. The server device according to claim 8, wherein
the conditions equivalent to elapse of defined times from occurrences of the events.

11. The server device according to claim 8, wherein
when the plurality of client terminals each includes video transmission and reception functions of transmitting visual data to the communication network,
the event is the change of the video transmission and reception functions of the client terminals from on to off.

12. The server device according to claim 8, wherein
the event is the temporary change of the number of the client terminals for switching users participating in the conference.

13. The conference system according to claim 8, wherein
the event is the change of call states among client terminals which form sessions in the groups.
